(19) United States
(12) Patent Application Publication
(10) Pub. No.: US 2026/0084203 A1
(43) Pub. Date: Mar. 26, 2026

(54) COIL SUPPLY DEVICE FOR HAIRPIN-TYPE STATOR COIL FORMING SYSTEM

(71) Applicants: Hyundai Motor Company, Seoul (KR); Kia Corporation, Seoul (KR)

(72) Inventors: Heewoong KIM, Hwaseong-si (KR); Jiwon YU, Hwaseong-si (KR); Yeongsu YU, Hwaseong-si (KR); Geon U CHOI, Hwaseong-si (KR); Gwangwon SUNG, Hwaseong-si (KR)

(21) Appl. No.: 19/240,102

(22) Filed: Jun. 17, 2025

(30) Foreign Application Priority Data
Sep. 25, 2024 (KR) 1020240129737

(51) Int. Cl. B21F 3/00; H02K 15/0421

(52) U.S. Cl. CPC B21F 3/00; H02K 15/0421

(57) ABSTRACT

A coil supply device is configured to supply a material coil to a coil forming system for forming a hairpin-type stator coil and includes a feeding case, a feeding belt connected to a belt driver disposed at the feeding case, coil gripper assemblies arranged at the feeding belt with intervals along a belt travel direction, an upper guide rail disposed an upper portion of the feeding case and having an upper cam projection section configured to come into cam contact with an upper cam mechanism, and a lower guide rail disposed at a lower portion of the feeding case and having a lower cam projection section configured to come into cam contact with a lower cam mechanism.

### CROSS-REFERENCE TO RELATED APPLICATION

This application claims priority to and the benefit of Korean Patent Application No. 10-2024-0129737, filed with the Korean Intellectual Property Office, on Sep. 25, 2024, the entire contents of which are incorporated herein by reference.

### TECHNICAL FIELD

The present disclosure relates to a hairpin-type stator coil forming system, and more specifically, to a coil supply device adapted to supply a material coil to a process for forming a hairpin-type stator coil.

### BACKGROUND

Hybrid vehicles or electric vehicles may be called environmentally-friendly vehicles that may generate driving force by a drive motor.

As part of efforts to reduce the weight and volume of vehicles and parts, automakers and environment-friendly part manufacturers are developing drive motors with stators wound with hairpin-type stator coils.

For example, a coil forming system for forming a hairpin-type stator coil can supply a material coil to a coil bending machine by a coil supply device and form the material coil into a set shape by the coil bending machine. The material coil here may be, for example, a square coil or flat coil.

In some cases, a coil supply device may supply a material coil to the coil bending machine while repeating a sequence of clamping the material coil through a single finger, conveying the finger to a set position along a straight section, unclamping the material coil through the finger, and returning the finger to its original position.

In some cases, the coil supply device may have a slow supply speed of the material coil due to the sequence of clamping and unclamping the finger, and conveying and returning the finger.

In some cases, the coil supply device may cause an increase in device size. This is because the finger clamps the material coil and is conveyed along a straight section corresponding to a set single supply amount (or supply length) of the material coil.

In some cases, the coil supply device may convey the material coil along the straight section with the single finger, and it may not maintain the flatness and straightness of the material coil supplied to the coil bending machine.

In some cases, the coil supply device may apply a pointed clamper to maximize the clamping force of the finger, which may cause damage to the material coil.

### SUMMARY

The present disclosure describes a coil supply device for a hairpin-type stator coil forming system, which enables increases in supply speed and supply amount of a material coil by simplifying a conveying sequence of the material coil.

According to one aspect of the subject matter described in this application, a coil supply device is configured to supply a material coil to a coil forming system for forming a hairpin-shaped stator coil. The coil supply device includes a feeding case configured to transfer the material coil from a front portion of the feeding case to a rear portion of the feeding case. The feeding case includes (i) a front coil guide coupled to the front portion of the feeding case and (ii) a rear coil guide coupled to the rear portion of the feeding case, the front and rear coil guides being configured to guide the material coil along a set coil conveying section disposed between the front portion and the rear portion of the feeding case. The coil supply device further includes a belt driver disposed at the feeding case, a feeding belt connected to the belt driver and configured to travel along a track, the feeding belt being divided into (i) straight sections disposed at lateral sides of the feeding case and (i) rounded sections disposed at front and rear sides of the feeding case, and a plurality of coil gripper assemblies arranged at the feeding belt at intervals along a belt travel direction of the feeding belt, where each of the coil gripper assemblies includes (i) an upper finger and a lower finger that are configured to move in an upper-lower direction, and (ii) an upper cam mechanism and a lower cam mechanism that are configured to move the upper finger and the lower finger in the upper-lower direction, respectively. The coil supply device further includes an upper guide rail mounted on an upper portion of the feeding case and having an upper cam projection section configured to come into cam contact with the upper cam mechanism at a position corresponding to the coil conveying section, and a lower guide rail disposed at a lower portion of the feeding case, the lower guide rail having a lower cam projection section configured to come into contact with the lower cam mechanism at a position corresponding to the coil conveying section.

Implementations according to this aspect can include one or more of the following features. For example, the belt driver can include a motor disposed at the feeding case, a drive pulley disposed in the feeding case and connected to the motor through a drive shaft, the drive pulley being configured to drive movement of the feeding belt, and a driven pulley disposed in the feeding case and spaced apart from the drive pully by a set interval, the driven pulley being connected to the drive pulley through the feeding belt.

In some implementations, each of the coil gripper assemblies can include a base plate coupled to the feeding belt, an upper finger holder that is fixed to an upper portion of the base plate and accommodates at least a portion of the upper finger, where the upper finger is configured to move relative to the upper finger holder in the upper-lower direction via at least one upper spring, a lower finger holder that is fixed to a lower portion of the base plate and accommodates at least a portion of the lower finger, where the lower finger is configured to move relative to the lower finger holder in the upper-lower direction via at least one lower spring, an upper cam roller rotatably disposed at an upper portion of the upper finger and configured to roll based on being in contact with the upper cam projection section, and a lower cam roller rotatably disposed at a lower portion of the lower finger and configured to roll based on being in contact with the lower cam projection section.

In some examples, the feeding belt can include nuts that are arranged on a belt surface in the upper-lower direction, and the base plate is fastened to the nuts via bolts. In some examples, the base plates of the coil gripper assemblies disposed at the straight sections of the feeding belt are in contact with the belt surface of the feeding belt, and the base plates of the coil gripper assemblies disposed at the rounded sections of the feeding belt are spaced apart from the belt surface of the feeding belt.

In some implementations, the coil supply device can further include a plurality of support blocks arranged between the coil gripper assemblies and fixed to the feeding belt.

In some implementations, the upper cam projection section and the lower cam projection section can be disposed along the coil conveying section at a position corresponding to one of the straight sections disposed at a first side of the feeding belt. In some examples, the upper guide rail can include an upper plane section that is connected to the upper cam projection section and that is disposed at positions corresponding to (i) another of the straight sections disposed at a second side of the feeding belt and (ii) the rounded sections of the feeding belt. The lower guide rail can include a lower plane section that is connected to the lower cam projection section and that is disposed at the positions corresponding to (i) the straight section disposed at the second side of the feeding belt and (ii) the rounded sections of the feeding belt.

In some examples, the upper cam projection section and the lower cam projection section define a coil gripping area of the coil gripper assemblies, and the upper plane section and the lower plane section define a coil ungripping area of the coil gripper assemblies. In some implementations, the coil gripper assemblies are configured to grip the material coil based on the upper finger and the lower finger moving toward each other by the upper cam mechanism and the lower cam mechanism, respectively, to thereby contact the upper cam projection section and the lower cam projection section in the coil gripping area.

In some implementations, the coil gripper assemblies are configured to ungrip the material coil based on the upper finger and the lower finger moving away from each other by the upper cam mechanism and the lower cam mechanism, respectively, to thereby contact the upper plane section and the lower plane section in the coil ungripping area.

In some implementations, the coil supply device can further include an upper rail height adjuster disposed at the upper portion of the feeding case and connected to the upper guide rail, and a lower rail height adjuster disposed at the lower portion of the feeding case and connected to the lower guide rail.

In some examples, the upper rail height adjuster can include a height adjustment cylinder that is fixed to the upper portion of the feeding case and can include an operating rod configured move forward and rearward in a front-rear direction, an upper slider connected to the operating rod and coupled to the upper portion of the feeding case, the upper slider being configured to move in the front-rear direction, an upper guider that connects the upper slider to the upper portion of the feeding case, at least one upper ball joint rotatably coupled to the upper slider, and at least one upper eccentric shaft rotatably coupled to the upper guide rail and coupled to the at least one upper ball joint.

In some implementations, the upper rail height adjuster can further include an adapter connected to the upper slider, and the operating rod is coupled to the adapter.

In some implementations, the lower rail height adjuster can include a ball screw rotatably coupled to the lower portion of the feeding case and arranged along a front-rear direction, a lower slider coupled to the ball screw and coupled to the lower portion of the feeding case, the lower slider being configured to move in the front-rear direction, a lower guider that connects the lower slider to the lower portion of the feeding case, at least one lower ball joint rotatably coupled to the lower slider, and at least one lower eccentric shaft rotatably coupled to the lower guide rail and coupled to the at least one lower ball joint.

In some implementations, it can be possible to increase the supply speed and supply amount of a material coil, to shorten the cycle time, and to reduce the size of the device.

In addition, the effects that can be obtained or expected by the implementations of the present disclosure will be directly or implicitly disclosed in the detailed description of the implementations of the present disclosure. That is, various effects that can be expected by the implementations of the present disclosure will be disclosed in the detailed description described below.

### BRIEF DESCRIPTION OF THE DRAWINGS

Since the accompanying drawings are for reference in describing implementations of the present disclosure, the technical spirit of the present disclosure should not be construed as being limited to the accompanying drawings.

FIG. 1 is a schematic view illustrating an example of a hairpin-type stator coil forming system including a coil supply device.

FIG. 2 is a perspective view illustrating an example of a coil supply device for a hairpin-type stator coil forming system.

FIG. 3 is a side view illustrating the coil supply device.

FIG. 4 is a partially exploded perspective view illustrating the coil supply device.

FIG. 5 is a cross-sectional view illustrating the coil supply device.

FIG. 6 is a cross-sectional view taken along line A-A of FIG. 3.

FIG. 7 is a perspective view illustrating an example of a belt mounting structure of a coil gripper assembly applied to the coil supply device.

FIG. 8 is a cross-sectional view illustrating the belt mounting structure of the coil gripper assembly applied to the coil supply device.

FIG. 9 is an exploded perspective view illustrating the coil gripper assembly applied to the coil supply device.

FIG. 10 is a side view illustrating the coil gripper assembly applied to the coil supply device.

FIG. 11 is a perspective view illustrating an example of an upper guide rail applied to the coil supply device.

FIG. 12 is a bottom view illustrating the upper guide rail applied to the coil supply device.

FIG. 13 is a perspective view illustrating an example of a lower guide rail applied to the coil supply device.

FIG. 14 is a plan view illustrating the lower guide rail applied to the coil supply device.

FIG. 15 is a view illustrating an example operating structure of coil gripper assemblies applied to the coil supply device.

FIG. 16 is a cross-sectional view illustrating an example of portions of an upper rail height adjuster and a lower rail height adjuster applied to the coil supply device.

FIG. 17 is a perspective view illustrating the portion of the upper rail height adjuster applied to the coil supply device.

FIG. 18 is a view illustrating an example of portions of an upper eccentric shaft and a lower eccentric shaft of the upper rail height adjuster and the lower rail height adjuster applied to the coil supply device.

FIG. 19 is a view for illustrating an example operation of the upper rail height adjuster applied to the coil supply device.

FIG. 20 is a perspective view illustrating the portion of the lower rail height adjuster applied to the coil supply device.

### DETAILED DESCRIPTION

The present disclosure will be described more fully hereinafter with reference to the accompanying drawings, in which implementations of the disclosure are shown. As those skilled in the art would realize, the described implementations can be modified in various different ways, all without departing from the spirit or scope of the present disclosure.

In the present application, the terms ‘vehicle’, ‘vehicular’, ‘automobile’ or other similar terms as used herein generally refer to passenger automobiles including passenger vehicles, sports utility vehicles (SUVs), buses, trucks, and various commercial vehicles, which can include hybrid automobiles equipped with high voltage batteries, electric automobiles, hybrid electric automobiles, electric vehicle-based PBVs (Purpose Built Vehicles), and hydrogen-powered vehicles (also commonly referred to by those skilled in the art as ‘hydrogen electric vehicles’).

Hereinafter, example implementations of the present disclosure will be described in detail with reference to the accompanying drawings.

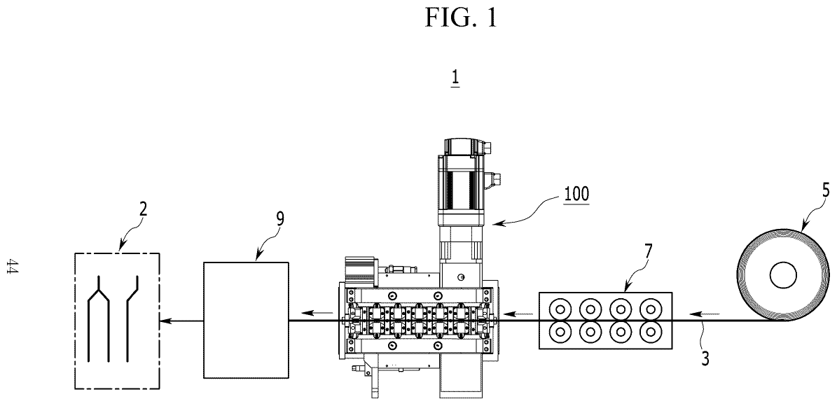

FIG. 1 is a schematic view of a hairpin-type stator coil forming system to which a coil supply device is applied.

Referring to FIG. 1, a coil supply device 100 can be configured in a hairpin-type stator coil forming system 1. The coil forming system 1 can be applied to a process for forming stator coils 2, among processes for manufacturing a stator on which hairpin-type stator coils 2 are wound.

The hairpin winding-type stator can be applied to a drive motor for an environmentally friendly vehicle that obtains drive force from electric energy, such as a hybrid vehicle and/or an electric vehicle.

In some examples, the hairpin-type stator coils 2 can also be referred to as conductor coils, segment coils or flat coils.

In an example, the stator coils 2 can be formed into U-shaped and I-shaped hairpin types by the coil forming system 1.

In some implementations, the coil forming system 1 can include a coil unwinder 5, a coil straightener 7, a coil supply device 100, and a coil forming machine 9.

For example, the coil forming system 1 can unwind a material coil 3 wound on the coil unwinder 5, flatten the material coil 3 through the coil straightener 7, and supply the flattened material coil 3 to the coil forming machine 9 along a set conveying path by the coil supply device 100.

The coil forming machine 9 can form the hairpin-type stator coils 2 through processes such as bending and cutting the material coil 3 into a set shape.

In the present specification, the reference direction for describing the following components can be set as the front-rear direction, left-right direction, and upper-lower direction based on the drawing.

Furthermore, in the present specification, an ‘upper end portion’, ‘upper portion’, ‘upper end’ or ‘upper surface’ of a component refers to an end portion, portion, end, or surface of the component located on a relatively upper side in the drawing, and a ‘lower end portion’, ‘lower portion’, ‘lower end’ or ‘lower surface’ of a component refers to an end portion, portion, end, or surface of the component located on a relatively lower side in the drawing.

Furthermore, in the present specification, an end of a component (e.g., an end on one side or an end on another (other) side, etc.) refers to an end of the component in any one direction, and an end portion of a component (e.g., an end portion on one side or an end portion on another (other) side, etc.) refers to a certain portion of the component including the end.

The coil supply device 100 for a hairpin-type stator coil forming system provides a structure capable of increasing the supply speed and supply amount of the material coil 3 by simplifying the conveying sequence of the material coil 3,

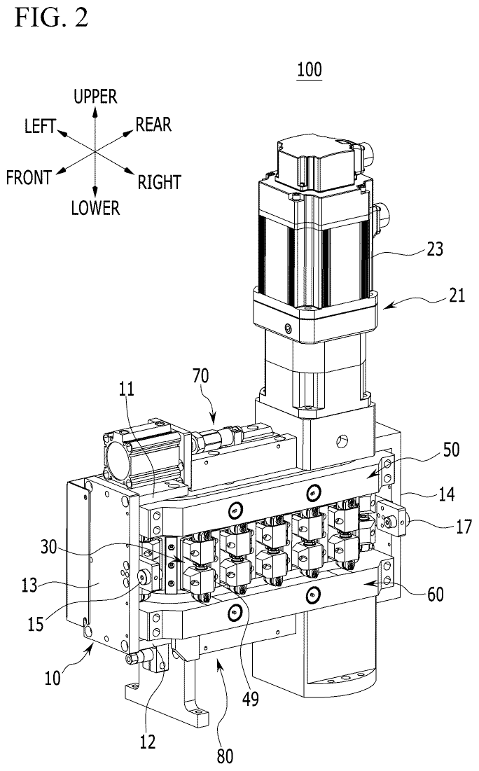

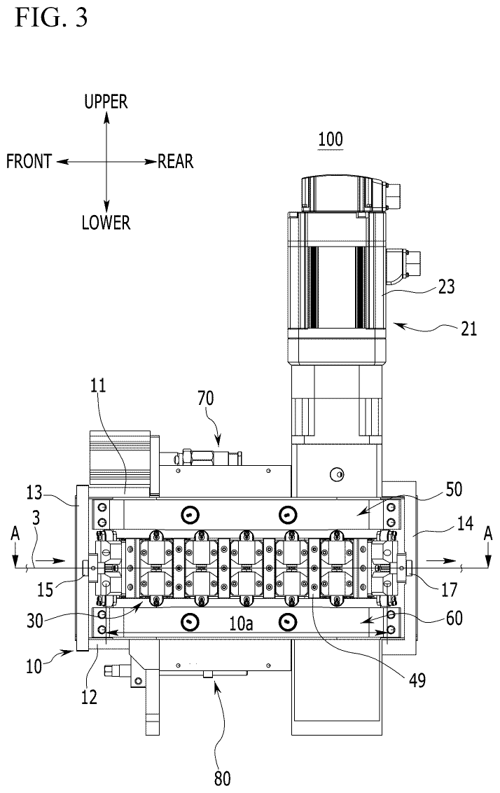

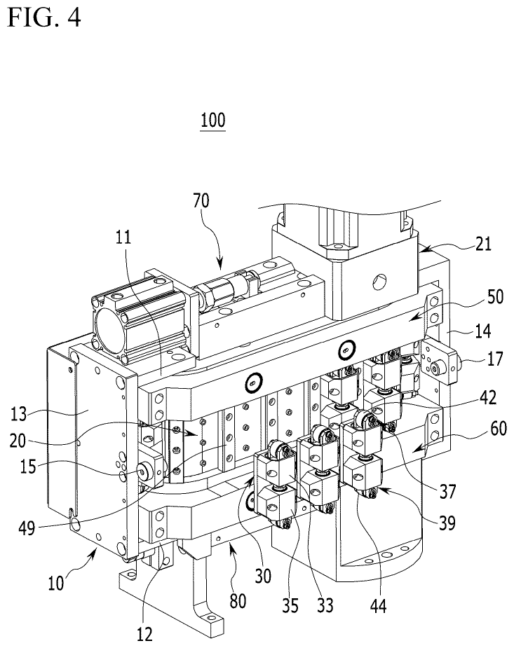

FIG. 2 is a perspective view illustrating a coil supply device, FIG. 3 is a side view illustrating the coil supply device, and FIG. 4 is a partially exploded perspective view illustrating the coil supply device.

Referring to FIGS. 2 to 4, the coil supply device 100 includes a feeding case 10, a feeding belt 20, coil gripper assemblies 30, an upper guide rail 50, a lower guide rail 60, an upper rail height adjuster 70, and a lower rail height adjuster 80.

In some implementations, the feeding case 10 is adapted to mount various components described below. The feeding case 10 can be composed of a single case body or a case body divided into two or more sections.

The feeding case 10 can include various auxiliary elements, such as brackets, plates, blocks, rods, and partitions, adapted to support each component.

In some cases, since the various auxiliary elements described above are intended to mount the respective components described below to the feeding case 10, in some examples, the various auxiliary elements described above may be collectively referred to as the feeding case 10.

The feeding case 10 can be provided in the form of a housing with both open left and right sides, as an example. The feeding case 10 includes an upper case portion 11, a lower case portion 12, a front case portion 13, and a rear case portion 14 coupled to one another.

The feeding case 10 further includes a front coil guide 15 and a rear coil guide 17.

The front coil guide 15 and the rear coil guide 17 are adapted to guide the material coil 3 pulled out from the coil straightener 7 (see FIG. 1) to the coil forming machine 9 (see FIG. 1) along a set coil conveying section 10a.

The front coil guide 15 is mounted on a front portion of the feeding case 10, and the rear coil guide 17 is mounted on a rear portion of the feeding case 10.

On an open portion side (right open portion based on the drawing) of the feeding case 10, the front coil guide 15 is mounted on the front case portion 13, and the rear coil guide 17 is mounted on the rear case portion 14.

The front coil guide 15 is provided in the form of a guide bush that introduces the material coil 3 into the coil conveying section 10a. In addition, the rear coil guide 17 is provided in the form of a guide bush that pulls out the material coil 3 from the coil conveying section 10a.

In some examples, the coil conveying section 10a is a straight section connecting the front coil guide 15 and the rear coil guide 17 along the front-rear direction, and in an example, can be formed at the right open portion of the feeding case 10.

In some implementations, the feeding belt 20 is installed to enable travel on an endless track along the front-rear direction inside the feeding case 10. In an example, the feeding belt 20 can include a timing belt.

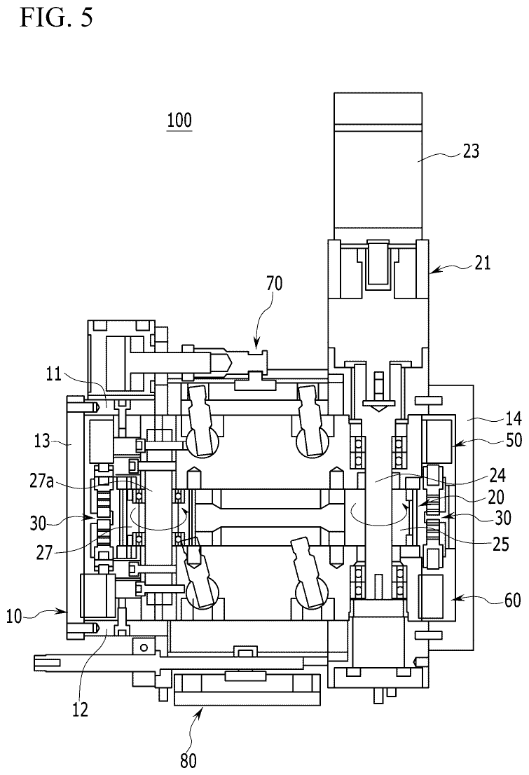

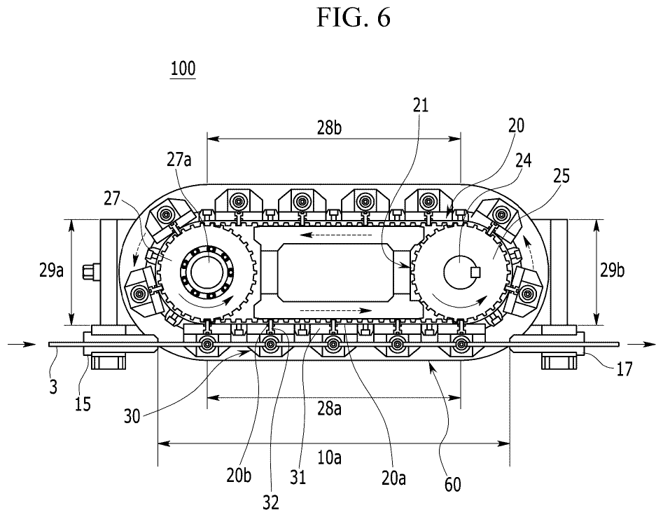

FIG. 5 is a cross-sectional view illustrating the coil supply device, and FIG. 6 is a cross-sectional view taken along line A-A of FIG. 3.

Referring to FIGS. 3 to 6, the feeding belt 20 is connected to a belt driver 21 installed on the feeding case 10 so as to enable travel on an endless track.

The belt driver 21 includes a servo motor 23, a drive pulley 25, and a driven pulley 27.

The servo motor 23 is installed on the upper case portion 11 of the feeding case 10. The servo motor 23 can be a motor capable of servo control of rotation direction and rotation speed.

The drive pulley 25 is connected to the servo motor 23 via a drive shaft 24 and is mounted in the feeding case 10 so as to enable drive rotation.

The driven pulley 27 is arranged at a set interval from the drive pulley 25 and is mounted in the feeding case 10 via a driven shaft 27a so as to enable driven rotation. The driven pulley 27 is connected to the drive pulley 25 via the feeding belt 20.

In some examples, the feeding belt 20 is connected to the drive pulley 25 and the driven pulley 27 in an endless track manner and can be divided into straight sections 28a and 28b on both sides and front and rear rounded sections 29a and 29b (see FIG. 6).

The straight sections 28a and 28b on both sides and the front and rear rounded sections 29a and 29b can be divided by the drive pulley 25 and the driven pulley 27. In the above, the straight sections 28a and 28b on both sides can be divided into a straight section 28a on one side located at the right open portion of the feeding case 10 and a straight section 28b on the other side located at the left open portion of the feeding case 10.

Referring to FIGS. 2 to 6, in some implementations, the coil gripper assemblies 30 are adapted to grip the material coil 3 in the coil conveying section 10a corresponding to the straight section 28a on one side of the entire travel section of the feeding belt 20.

In addition, the coil gripper assemblies 30 are adapted to ungrip the material coil 3 in the straight section 28b on the other side and the front and rear rounded sections 29a and 29b of the feeding belt 20.

The coil gripper assemblies 30 are mounted on the feeding belt 20 at set intervals along the belt travel direction.

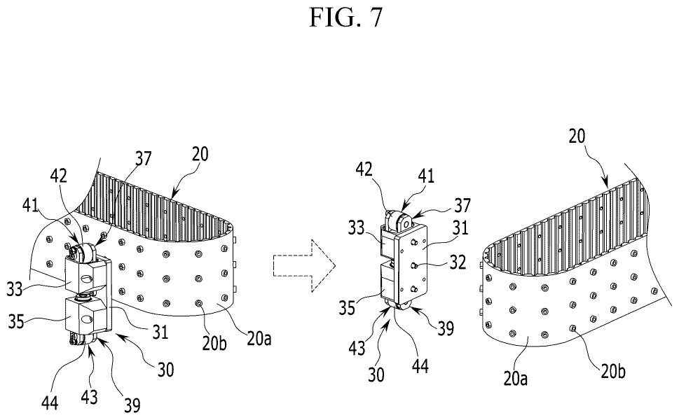

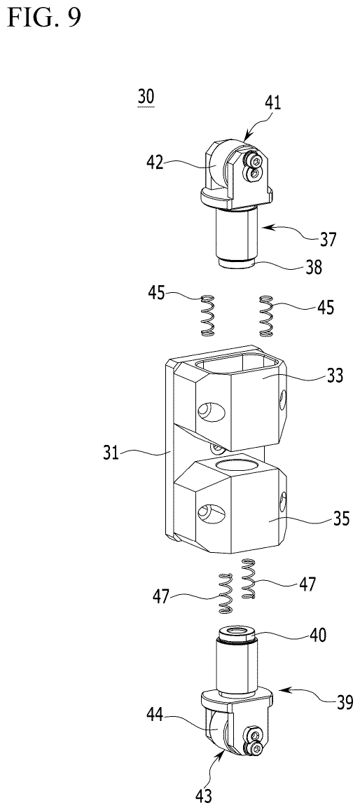

FIGS. 7 to 10 are views illustrating a coil gripper assembly applied to the coil supply device.

Referring to FIGS. 7 to 10, each of the coil gripper assemblies 30 includes a base plate 31, an upper finger holder 33, a lower finger holder 35, an upper finger 37, a lower finger 39, an upper cam mechanism 41, and a lower cam mechanism 43.

The base plate 31 is coupled to a belt surface 20a of the feeding belt 20. The base plate 31 can be fastened to nuts 20b attached to the belt surface 20a of the feeding belt 20 along the upper-lower direction via bolts 32, in an example.

The base plate 31 can swing in the belt travel direction on the belt surface 20a as it is fastened to the belt surface 20a of the feeding belt 20 by the nuts 20b and bolts 32.

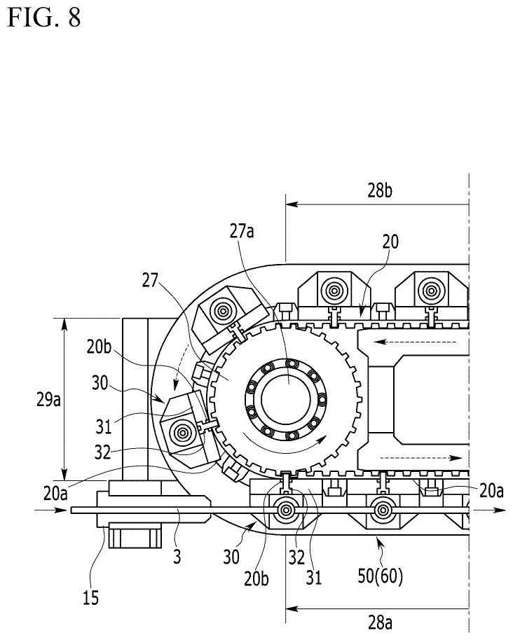

In some implementations, the base plate 31 can be in close contact with the belt surface 20a in the straight sections 28a and 28b on both sides of the feeding belt 20, with the bolts 32 and nuts 20b being centered. The base plate 31 can be spaced apart from the belt surface 20a in the front and rear rounded sections 29a and 29b of the feeding belt 20, with the bolts 32 and nuts 20b being centered (see FIGS. 6 and 8).

The upper finger holder 33 is fixed to an upper portion of the base plate 31. The lower finger holder 35 is fixed to a lower portion of the base plate 31. The upper finger holder 33 and the lower finger holder 35 can each be provided in the form of a housing with open upper and lower ends.

The upper finger 37 is mounted to the upper finger holder 33 so as to be movable in the upper-lower direction. The upper finger 37 penetrates the upper finger holder 33 in the upper-lower direction.

The upper finger 37 is elastically supported in the upper finger holder 33 by at least one upper spring 45 arranged inside the upper finger holder 33.

The upper finger 37 can move downward while overcoming elastic force of at least one upper spring 45. The upper finger 37 can move upward by elastic restoring force of at least one upper spring 45.

In some examples, the upper finger 37 includes an upper gripping portion 38 formed at a lower portion.

The lower finger 39 is mounted to the lower finger holder 35 so as to be movable in the upper-lower direction. The lower finger 39 penetrates the lower finger holder 35 in the upper-lower direction.

The lower finger 39 is elastically supported in the lower finger holder 35 by at least one lower spring 47 arranged inside the lower finger holder 35.

The lower finger 39 can move upward while overcoming elastic force of at least one lower spring 47. The lower finger 39 can move downward by elastic restoring force of at least one lower spring 47.

In some examples, the lower finger 39 includes a lower gripping portion 40 formed at an upper portion.

The upper cam mechanism 41 is mounted to the upper portion of the upper finger 37. In an example, the upper cam mechanism 41 can include an upper cam roller 42 rotatably mounted to the upper portion of the upper finger 37. The upper cam roller 42 can be in rolling contact (or cam contact) with the upper guide rail 50 described below.

The lower cam mechanism 43 is mounted to the lower portion of the lower finger 39. In an example, the lower cam mechanism 43 can include a lower cam roller 44 rotatably mounted to the lower portion of the lower finger 39. The lower cam roller 44 can be in rolling contact (or cam contact) with the lower guide rail 60 described below.

In some examples, as the upper cam roller 42 comes into cam contact with the upper guide rail 50, the upper finger 37 can be moved up and down through at least one upper spring 45.

As the lower cam roller 44 comes into cam contact with the lower guide rail 60, the lower finger 39 can be moved up and down through at least one lower spring 47.

Accordingly, the upper finger 37 and the lower finger 39 can grip or ungrip the material coil 3 through the upper gripping portion 38 and the lower gripping portion 40 by varying a gap between the upper gripping portion 38 and the lower gripping portion 40.

The coil gripper assemblies 30 can be positioned at set positions on the feeding belt 20 by support blocks 49 as shown in FIGS. 2 to 4.

The support blocks 49 are arranged between the coil gripper assemblies 30, respectively, and can be fixed to the belt surface 20a of the feeding belt 20 by a fastening member composed of a combination of a bolt and a nut.

In some examples, the support blocks 49 can position the coil gripper assemblies 30 at set positions on the belt surface 20a while supporting the coil gripper assemblies 30, because the base plates 31 of the coil gripper assemblies 30 can swing on the belt surface 20a during the travel of the feeding belt 20, as described above.

Referring to FIGS. 2 to 4, in some implementations, the upper guide rail 50 and the lower guide rail 60 are adapted to guide the coil gripper assemblies 30 along the belt travel direction throughout the entire travel section of the feeding belt 20 during the travel of the feeding belt 20.

Additionally, the upper guide rail 50 and the lower guide rail 60 are adapted to guide coil gripping of the coil gripper assemblies 30 in the coil conveying section 10a corresponding to the straight section 28a on one side of the feeding belt 20.

Furthermore, the upper guide rail 50 and the lower guide rail 60 are adapted to guide coil ungripping of the coil gripper assemblies 30 in the straight section 28b on the other side and the front and rear rounded sections 29a and 29b of the feeding belt 20.

The upper guide rail 50 as described above is mounted to the upper portion of the feeding case 10 at a position corresponding to the upper cam rollers 42 of the coil gripper assemblies 30. The lower guide rail 60 as described above is mounted to the lower portion of the feeding case 10 at a position corresponding to the lower cam rollers 44 of the coil gripper assemblies 30.

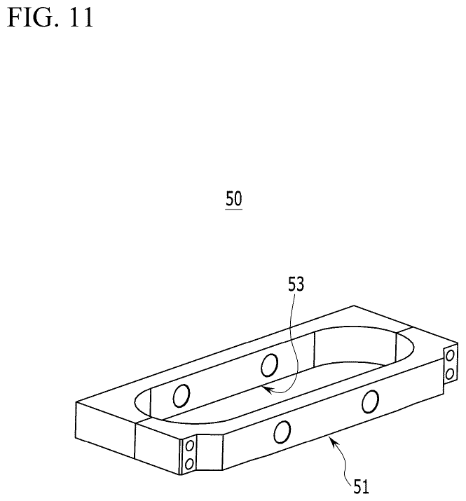

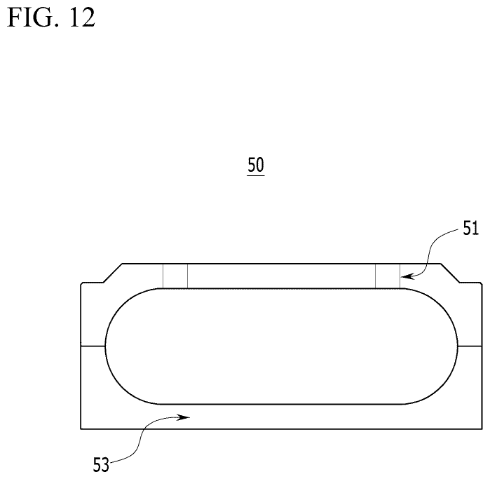

FIG. 11 is a perspective view illustrating an upper guide rail applied to the coil supply device, and FIG. 12 is a bottom view illustrating the upper guide rail applied to the coil supply device.

Referring to FIGS. 4, 6, and 9 to 12, the upper guide rail 50 includes an upper cam projection section 51 and an upper plane section 53 formed on a bottom surface.

The upper cam projection section 51 is formed in the front-rear direction along the coil conveying section 10a at a position corresponding to the straight section 28a on one side of the feeding belt 20. The upper cam projection section 51 can be formed as a projection section protruding downward from the bottom surface of the upper guide rail 50 and extending in the front-rear direction.

The upper cam projection section 51 can come into cam contact with the upper cam rollers 42 of the coil gripper assemblies 30 at a position corresponding to the coil conveying section 10a.

The upper cam projection section 51 is a cam follower section that comes into rolling contact with the upper cam roller 42, and can move the upper finger 37 downward through the upper cam roller 42.

The upper plane section 53 is connected to the upper cam projection section 51 at a position corresponding to the straight section 28b on the other side and the front and rear rounded sections 29a and 29b of the feeding belt 20.

The upper plane section 53 is a plane section having a height difference from the upper cam projection section 51 on the bottom surface of the upper guide rail 50, and is formed in a remaining area of the bottom surface of the upper guide rail 50 excluding the upper cam projection section 51.

In the upper plane section 53, the upper cam rollers 42 of the coil gripper assemblies 30 are in rolling contact, and the upper finger 37 can be moved upward by the elastic restoring force of at least one upper spring 45.

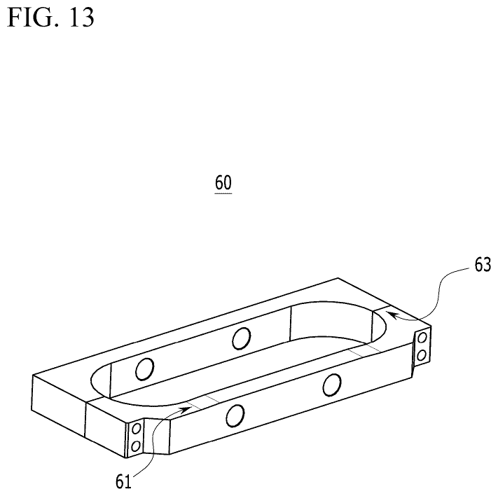

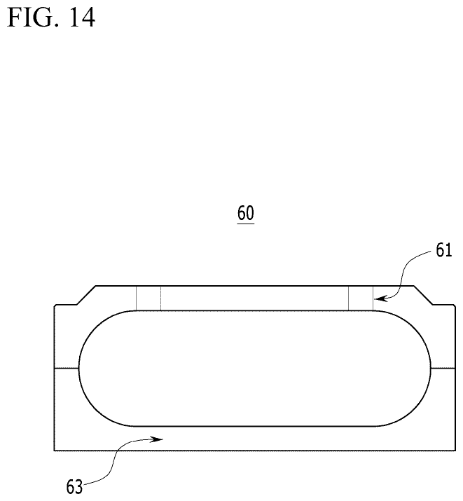

FIG. 13 is a perspective view illustrating a lower guide rail applied to the coil supply device, and FIG. 14 is a plan view illustrating the lower guide rail applied to the coil supply device.

Referring to FIGS. 4, 6, 9, 10, 13, and 14, the lower guide rail 60 includes a lower cam projection section 61 and a lower plane section 63 formed on an upper surface.

The lower cam projection section 61 is formed in the front-rear direction along the coil conveying section 10a at a position corresponding to the straight section 28a on one side of the feeding belt 20. The lower cam projection section 61 can be formed as a projection section protruding upward from the upper surface of the lower guide rail 60 and extending in the front-rear direction.

The lower cam projection section 61 can come into cam contact with the lower cam rollers 44 of the coil gripper assemblies 30 at a position corresponding to the coil conveying section 10a.

The lower cam projection section 61 is a cam follower section that comes into rolling contact with the lower cam roller 44, and can move the lower finger 39 upward through the lower cam roller 44.

The lower plane section 63 is connected to the lower cam projection section 61 at a position corresponding to the straight section 28b on the other side and the front and rear rounded sections 29a and 29b of the feeding belt 20.

The lower plane section 63 is a plane section having a height difference from the lower cam projection section 61 on the upper surface of the lower guide rail 60, and is formed in a remaining area of the upper surface of the lower guide rail 60 excluding the lower cam projection section 61.

In the lower plane section 63, the lower cam rollers 44 of the coil gripper assemblies 30 are in rolling contact, and the lower finger 39 can be moved downward by the elastic restoring force of at least one lower spring 47.

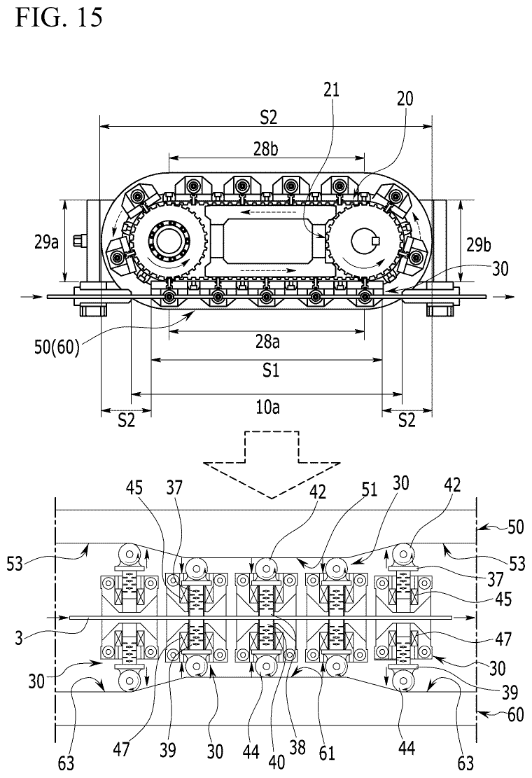

Accordingly, referring to FIG. 15, the upper cam projection section 51 of the upper guide rail 50 and the lower cam projection section 61 of the lower guide rail 60 can be provided as a coil gripping area (S1) by the coil gripper assemblies 30.

The upper plane section 53 of the upper guide rail 50 and the lower plane section 63 of the lower guide rail 60 can be provided as a coil ungripping area (S2) by the coil gripper assemblies 30.

In the coil gripping area (S1), each of the upper fingers 37 of the coil gripper assemblies 30 can move downward while overcoming the elastic force of at least one upper spring 45.

In the coil gripping area (S1), each of the lower fingers 39 of the coil gripper assemblies 30 can move upward while overcoming the elastic force of at least one lower spring 47.

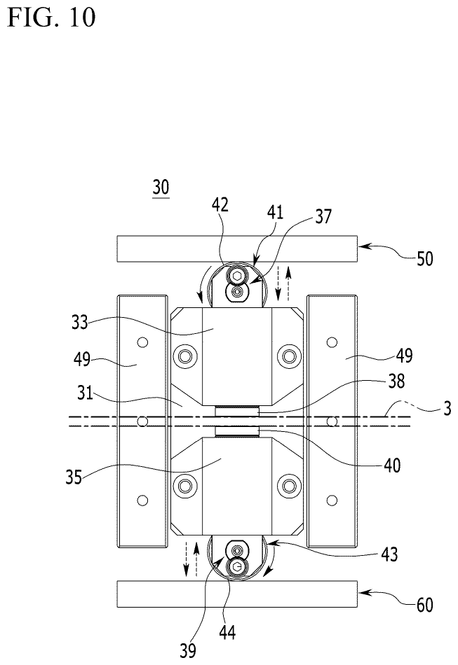

Accordingly, the upper finger 37 and the lower finger 39 can move toward each other and grip the material coil 3 through the upper gripping portion 38 and the lower gripping portion 40 (see FIGS. 10 and 15).

In the coil ungripping area (S2), each of the upper fingers 37 of the coil gripper assemblies 30 can move upward by the elastic restoring force of at least one upper spring 45.

In the coil ungripping area (S2), each of the lower fingers 39 of the coil gripper assemblies 30 can move downward by the elastic restoring force of at least one lower spring 47.

Accordingly, the upper finger 37 and the lower finger 39 can move away from each other and ungrip (release) the material coil 3 through the upper gripping portion 38 and the lower gripping portion 40 (see FIGS. 10 and 15).

Referring to FIGS. 2 to 5, in some implementations, the upper rail height adjuster 70 is adapted to adjust an upper-lower height of the upper guide rail 50.

In some implementations, the lower rail height adjuster 80 is adapted to adjust an upper-lower height of the lower guide rail 60.

Furthermore, the upper rail height adjuster 70 and the lower rail height adjuster 80 can adjust the gap between the upper guide rail 50 and the lower guide rail 60 depending on a size (e.g., thickness) of the material coil 3, and adjust (or determine) the coil gripping force of the coil gripper assemblies 30.

Below, the configuration of the upper rail height adjuster 70 and the lower rail height adjuster 80 will be described. The upper rail height adjuster 70 is installed on the upper portion of the feeding case 10 and is operably connected to the upper guide rail 50.

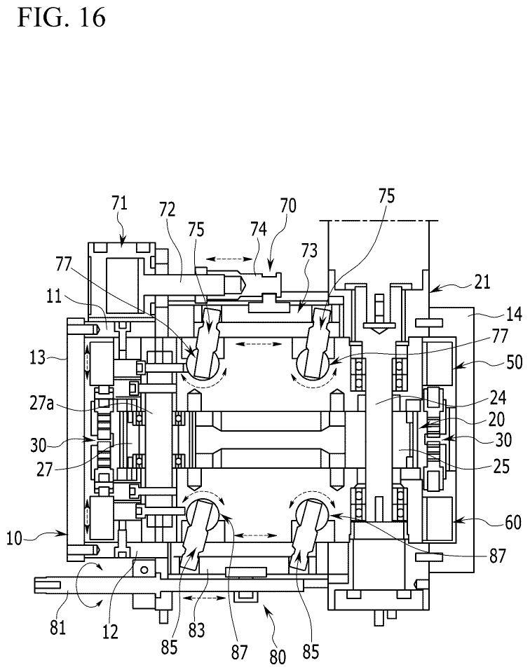

FIG. 16 is a cross-sectional view illustrating an upper rail height adjuster and a lower rail height adjuster applied to the coil supply device.

Referring to FIGS. 5 and 16, the upper rail height adjuster 70 includes a height adjustment cylinder 71, an upper slider 73, at least one upper ball joint 75, and at least one upper eccentric shaft 77.

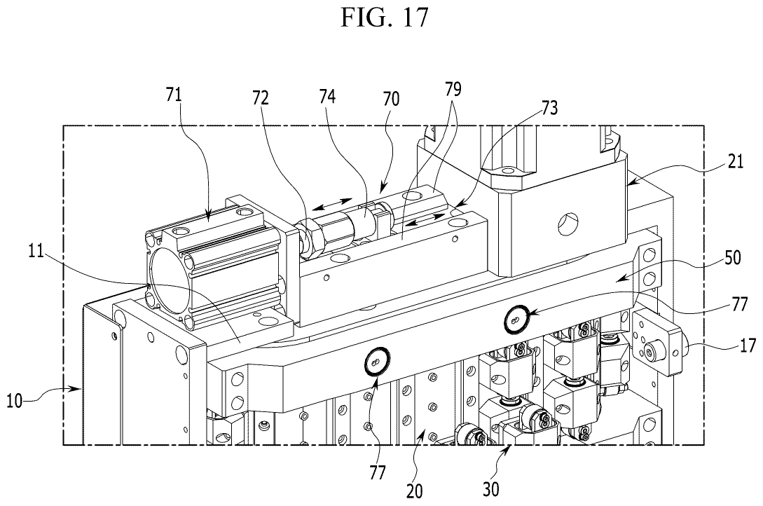

The height adjustment cylinder 71 is fixed to the upper case portion 11 of the feeding case 10, as shown in FIGS. 16 and 17. The height adjustment cylinder 71 includes an operating rod 72 that can move forward and rearward in the front-rear direction. In an example, the height adjustment cylinder 71 can include a pneumatic cylinder.

The upper slider 73 is coupled to the upper case portion 11 so as to be slidably movable in the front-rear direction at a position corresponding to the upper guide rail 50. The upper slider 73 is connected to the operating rod 72 of the height adjustment cylinder 71. The upper slider 73 can move in the front-rear direction along an upper guider 79 fixed to the upper case portion 11.

In some examples, the operating rod 72 of the height adjustment cylinder 71 can be screw-coupled to an adapter 74 connected to the upper slider 73. The adapter 74 can be provided in the form of a female screw. In some examples, the adapter 74 is screw-coupled to the operating rod 72 in a male-female manner and can adjust an amount of forward and rearward movement of the upper slider 73.

The at least one upper ball joint 75 is swivel-rotatably coupled to a lower portion of the upper slider 73 at a position corresponding to the upper guide rail 50. The at least one upper ball joint 75 can be provided as a pair, in an example.

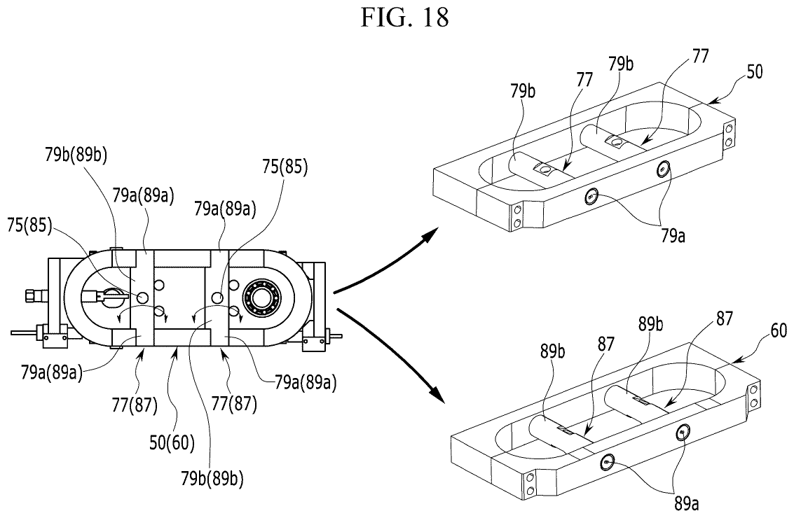

The at least one upper eccentric shaft 77 is arranged along the left-right direction on the upper guide rail 50 as shown in FIGS. 16 and 18 and is eccentrically rotatably mounted to the upper guide rail 50. The at least one upper eccentric shaft 77 is coupled to at least one upper ball joint 75. The at least one upper eccentric shaft 77 can be provided as a pair, in an example.

In some examples, at least one upper eccentric shaft 77 can include eccentric coupling portions 79a formed at both end portions, respectively, and an eccentric rotating portion 79b formed between the eccentric coupling portions 79a.

The eccentric coupling portions 79a are formed at positions deviating from an axis center of the eccentric rotating portion 79b at both end portions of at least one upper eccentric shaft 77 and are coupled to the upper guide rail 50 through bearings. The eccentric rotating portion 79b is coupled to at least one upper ball joint 75.

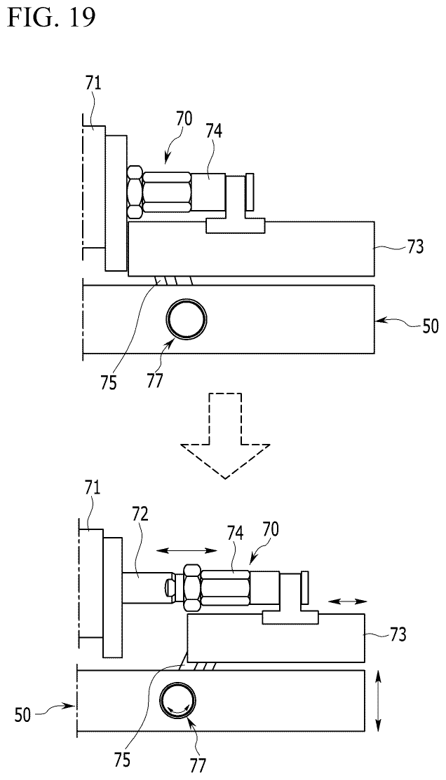

Accordingly, as shown in FIG. 19, when the operating rod 72 moves forward and rearward along the front-rear direction by an operation of the height adjustment cylinder 71, the upper slider 73 can move forward and rearward along the upper guider 79 by the operating rod 72.

Accordingly, since the at least one upper ball joint 75 is swivel-rotatably coupled to the upper slider 73 and coupled to at least one upper eccentric shaft 77, the upper guide rail 50 can move along the upper-down direction by eccentric rotation of at least one upper eccentric shaft 77.

In some examples, an amount of forward and rearward movement of the upper slider 73 can be determined by a fastening amount (e.g., fastening length) of the operating rod 72 and the adapter 74. An amount of movement in the upper-lower direction of the upper guide rail 50 can be determined by the amount of forward and rearward movement of the upper slider 73.

Referring to FIGS. 2 to 5, in some implementations, the lower rail height adjuster 80 is installed on the lower portion of the feeding case 10 and is operably connected to the lower guide rail 60.

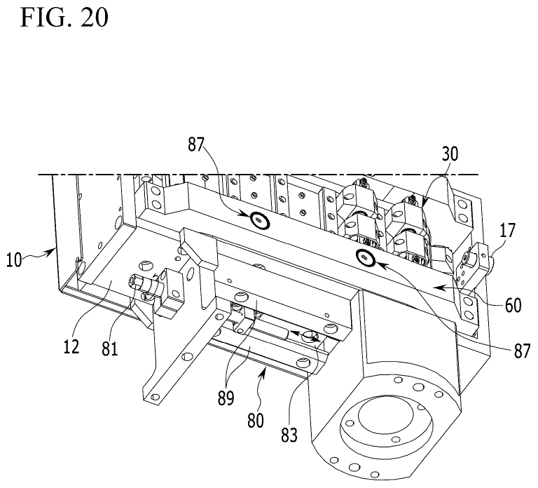

FIG. 20 is a perspective view illustrating the portion of the lower rail height adjuster applied to the coil supply device.

Referring to FIGS. 16 and 20, the lower rail height adjuster 80 includes a ball screw 81, a lower slider 83, at least one lower ball joint 85, and at least one lower eccentric shaft 87.

The ball screw 81 is arranged along the front-rear direction in the lower case portion 12 of the feeding case 10 and is rotatably coupled to the lower case portion 12. In an example, the ball screw 81 can be manually rotated in forward and reverse directions.

The lower slider 83 is coupled to the lower case portion 12 so as to be slidably movable in the front-rear direction at a position corresponding to the lower guide rail 60. The lower slider 83 is screw-coupled to the ball screw 81. The lower slider 83 can move in front-rear direction along a lower guider 89 fixed to the lower case portion 12.

The at least one lower ball joint 85 is swivel-rotatably coupled to the lower portion of the lower slider 83 at a position corresponding to the lower guide rail 60. The at least one lower ball joint 85 can be provided as a pair, in an example.

The at least one lower eccentric shaft 87 is arranged along the left-right direction on the lower guide rail 60 as shown in FIGS. 18 and 20 and is eccentrically rotatably mounted to the lower guide rail 60. The at least one lower eccentric shaft 87 is coupled to at least one lower ball joint 85. The at least one lower eccentric shaft 87 can be provided as a pair, in an example.

In some examples, at least one lower eccentric shaft 87 can include eccentric coupling portions 89a formed at both end portions, respectively, and an eccentric rotating portion 89b formed between the eccentric coupling portions 89a.

The eccentric coupling portions 89a are formed at positions deviating from an axis center of the eccentric rotating portion 89b at both end portions of at least one lower eccentric shaft 87 and are coupled to the lower guide rail 60 through bearings. The eccentric rotating portion 89b is coupled to at least one lower ball joint 85.

Therefore, when the ball screw 81 rotates in the forward and reverse directions, the lower slider 83 can move forward and rearward in the front-rear direction along the lower guider 89.

Accordingly, since the at least one lower ball joint 85 is swivel-rotatably coupled to the lower slider 83 and coupled to at least one lower eccentric shaft 87, the lower guide rail 60 can move along the upper-lower direction by eccentric rotation of at least one lower eccentric shaft 87.

In some examples, an amount of forward and rearward movement of the lower slider 83 can be determined by an amount of forward and reverse rotation of the ball screw 81. An amount of movement in the upper-lower direction of the lower guide rail 60 can be determined by the amount of forward and rearward movement of the lower slider 83.

Below, an operation of the coil supply device configured as described above will be described in detail with reference to FIGS. 1 to 20.

First, in a process for forming the hairpin-type stator coils 2, when the coil unwinder 5 unwinds the material coil 3, the coil straightener 7 flattens the material coil 3.

The material coil 3 flattened by the coil straightener 7 is supplied to the coil forming machine 9 by the coil supply device 100. Then, the coil forming machine 9 bends the material coil 3 into a set shape and forms the hairpin-type stator coils 2.

Specifically describing the process for supplying the material coil 3 using the coil supply device 100, first, the feeding belt 20 is connected to the drive pulley 25 and driven pulley 27 of the belt driver 21.

The coil gripper assemblies 30 are mounted continuously along the belt travel direction on the belt surface 20a of the feeding belt 20. Additionally, the support blocks 49 are arranged between the coil gripper assemblies 30, respectively, and the support blocks 49 are fixed to the belt surface 20a of the feeding belt 20.

In this state, when the servo motor 23 of the belt driver 21 operates, the drive pulley 25 connected to the servo motor 23 through the drive shaft 24 performs drive rotation. Then, the driven pulley 27 connected to the drive pulley 25 through the feeding belt 20 performs driven rotation. Accordingly, the feeding belt 20 travels on an endless track along the front-rear direction by the rotation of the drive pulley 25 and the driven pulley 27.

During this process, the material coil 3 that has passed through the coil straightener 7 is introduced into the coil conveying section 10a through the front coil guide 15 of the feeding case 10.

Note that, as described above, when the feeding belt 20 travels, the coil gripper assemblies 30 travel along the upper guide rail 50 and the lower guide rail 60 by the feeding belt 20.

The upper guide rail 50 and the lower guide rail 60 guide the coil gripper assemblies 30 along the belt travel direction throughout the entire travel section of the feeding belt 20.

In the straight section 28a on one side of the entire travel section of the feeding belt 20, the upper cam rollers 42 of the coil gripper assemblies 30 come into rolling contact with the upper cam projection section 51 of the upper guide rail 50. Then, in the straight section 28a on one side, the lower cam rollers 44 of the coil gripper assemblies 30 come into rolling contact with the lower cam projection section 61 of the lower guide rail 60.

In some examples, the upper cam projection section 51 of the upper guide rail 50 and the lower cam projection section 61 of the lower guide rail 60 can be set as the coil gripping area (S1) at a position corresponding to the coil conveying section 10a.

In the coil gripping area (S1), each of the upper fingers 37 of the coil gripper assemblies 30 moves downward while overcoming the elastic force of at least one upper spring 45 through the upper cam roller 42.

Then, in the coil gripping area (S1), each of the lower fingers 39 of the coil gripper assemblies 30 moves upward while overcoming the elastic force of at least one lower spring 47 through the lower cam roller 44.

Accordingly, the upper finger 37 and the lower finger 39 move toward each other.

Accordingly, as described above, when the material coil 3 is introduced into the coil conveying section 10a through the front coil guide 15, the upper finger 37 and the lower finger 39 grip the material coil 3 through the upper gripping portion 38 and the lower gripping portion 40.

Accordingly, the material coil 3 gripped by the coil gripper assemblies 30 is fed along the coil conveying section 10a of the straight section, as the coil gripper assemblies 30 travel along the front-rear direction by the feeding belt 20 in the straight section 28a on one side of the feeding belt 20.

During this process, the coil gripper assemblies 30 move out of the upper cam projection section 51 of the upper guide rail 50 and the lower cam projection section 61 of the lower guide rail 60.

Then, in the straight section 28b on the other side and the front and rear rounded sections 29a and 29b of the feeding belt 20, the upper cam rollers 42 of the coil gripper assemblies 30 come into rolling contact with the upper plane section 53 of the upper guide rail 50. In addition, in the straight section 28b on the other side and the front and rear rounded sections 29a and 29b, the lower cam rollers 44 of the coil gripper assemblies 30 come into rolling contact with the lower plane section 63 of the lower guide rail 60.

In some examples, the upper plane section 53 of the upper guide rail 50 and the lower plane section 63 of the lower guide rail 60 can be set as the coil ungripping areas (S2) at positions corresponding to the straight section 28b on the other side and the front and rear rounded sections 29a and 29b of the feeding belt 20.

In the coil ungripping areas (S2), each of the upper fingers 37 of the coil gripper assemblies 30 moves upward by the elastic restoring force of at least one upper spring 45 through the upper cam roller 42.

Then, in the coil ungripping areas (S2), each of the lower fingers 39 of the coil gripper assemblies 30 moves downward by the elastic restoring force of at least one lower spring 47 through the lower cam roller 44.

Accordingly, the upper finger 37 and the lower finger 39 move away from each other.

Accordingly, when the coil gripper assemblies 30 move out of the coil gripping area (S1) and enter the coil ungripping areas (S2), the upper finger 37 and the lower finger 39 ungrip the material coil 3 through the upper gripping portion 38 and the lower gripping portion 40.

Accordingly, according to the coil supply device 100, in the coil gripping area (S1) at a position corresponding to the straight section 28a on one side of the feeding belt 20, the coil gripper assemblies 30 can grip the material coil 3 and feed it along the coil conveying section 10a of the straight section.

In the coil ungripping areas (S2) at positions corresponding to the straight section 28b on the other side and the front and rear rounded sections 29a and 29b of the feeding belt 20, the coil gripper assemblies 30 can ungrip the material coil 3.

As described above, the material coil 3 fed along the coil conveying section 10a can be pulled out from the coil conveying section 10a through the rear coil guide 17 of the feeding case 10 and supplied to the coil forming machine 9.

In some examples, the base plate 31 of each of the coil gripper assemblies 30 is fastened to the belt surface 20a of the feeding belt 20 by the nuts 20b and bolts 32.

Accordingly, the coil gripper assemblies 30 can swing in the belt travel direction on the belt surface 20a of the feeding belt 20, with the bolts 32 and nuts 20b centered by the base plate 31.

Accordingly, the coil gripper assemblies 30 are brought into close contact with the belt surface 20a through the base plates 31 in the straight sections 28a and 28b on both sides of the feeding belt 20 during the travel on an endless track through the feeding belt 20. The coil gripper assemblies 30 are spaced from the belt surface 20a through the base plates 31 in the front and rear rounded sections 29a and 29b of the feeding belt 20.

In some examples, the coil gripper assemblies 30 that can swing on the belt surface 20a of the feeding belt 20 are positioned at set positions on the feeding belt 20 by the support blocks 49. That is, the support blocks 49 can support the coil gripper assemblies 30 and position the coil gripper assemblies 30 at the set positions on the belt surface 20a.

In some examples, in the coil gripping area (S1), the gripping force of the coil gripper assemblies 30 gripping the material coil 3 can be adjusted by the upper rail height adjuster 70 and the lower rail height adjuster 80.

Specifically, when the operating rod 72 moves forward and rearward along the front-rear direction by the operation of the height adjustment cylinder 71 of the upper rail height adjuster 70, the upper slider 73 moves forward and rearward in the front-rear direction. In this case, the amount of forward and rearward movement of the upper slider 73 is determined by the amount of fastening between the operating rod 72 and the adapter 74 screw-coupled to each other.

In some examples, at least one upper ball joint 75 is swivel-rotatably coupled to the upper slider 73, and at least one upper ball joint 75 is coupled to at least one upper eccentric shaft 77.

Accordingly, when the upper slider 73 moves forward and rearward, the upper guide rail 50 moves along the upper-lower direction by the eccentric rotation of at least one upper eccentric shaft 77. In this case, the amount of movement in the upper-lower direction of the upper guide rail 50 is determined by the amount of forward and rearward movement of the upper slider 73.

When the ball screw 81 of the lower rail height adjuster 80 rotates in the forward and reverse directions, the lower slider 83 moves forward and rearward in the front-rear direction. In this case, the amount of forward and rearward movement of the lower slider 83 is determined by the amount of forward and reverse rotation of the ball screw 81.

In some examples, at least one lower ball joint 85 is swivel-rotatably coupled to the lower slider 83, and at least one lower ball joint 85 is coupled to at least one lower eccentric shaft 87.

Accordingly, when the lower slider 83 moves forward and rearward, the lower guide rail 60 moves along the upper-lower direction by the eccentric rotation of at least one lower eccentric shaft 87. In this case, the amount of movement in the upper-lower direction of the lower guide rail 60 is determined by the amount of forward and rearward movement of the lower slider 83.

Accordingly, the upper rail height adjuster 70 and the lower rail height adjuster 80 as described above can adjust the upper-lower heights of the upper guide rail 50 and the lower guide rail 60 depending on the size of the material coil 3, and adjust the coil gripping force of the coil gripper assemblies 30.

According to the coil supply device 100 as described so far, the coil gripper assemblies 30 are mounted on the feeding belt 20 traveling on an endless track.

In some implementations, the coil gripper assemblies 30 can grip the material coil 3 in the coil gripping area (S1) by the upper guide rail 50 and the lower guide rail 60, and supply the material coil 3 to the coil forming machine 9 along the coil conveying section 10a.

In some implementations, the coil gripper assemblies 30 can ungrip the material coil 3 in the coil ungripping areas (S2) by the upper guide rail 50 and the lower guide rail 60

Therefore, the coil supply device 100 can increase the supply speed and supply amount of the material coil 3, shorten the cycle time, and reduce the size of the device, compared to the related art in which the sequence of conveying the finger in the straight section and returning it is applied.

In addition, the coil supply device 100 can grip and ungrip the material coil 3 by the cam operation of the coil gripper assemblies 30, the upper guide rail 50, and the lower guide rail 60 as described above.

Accordingly, according to the coil supply device 100, a separate actuator for gripping or ungripping the material coil 3 may not be provided, resulting in a reduction in the number of parts of the device.

According to the coil supply device 100, since the plurality of coil gripper assemblies 30 grip the material coil 3 and feed it along the coil conveying section 10a, the flatness and straightness of the material coil 3 supplied to the coil forming machine 9 can be maintained.

Furthermore, since the coil supply device 100 grips the material coil 3 through the plurality of coil gripper assemblies 30, the coil gripping force can be uniformly distributed to the material coil 3.

Therefore, the coil supply device 100 can prevent damage to the material coil 3 due to coil gripping force during the processes of gripping and feeding the material coil 3 through the coil gripper assemblies 30.

Furthermore, the coil supply device 100 can adjust the gripping force of the coil gripper assemblies 30 by the upper rail height adjuster 70 and the lower rail height adjuster 80, which adjust the heights of the upper guide rail 50 and the lower guide rail 60.

Therefore, the coil supply device 100 can supply the material coils 3 of various sizes (e.g., thicknesses), as a single device.

Although the implementations of the present disclosure have been described above, the technical idea of the present disclosure is not limited to the implementations presented in the present specification, and one skilled in the art who understands the technical idea of the present disclosure will be able to easily propose other implementations by adding, changing, deleting, or adding components within the scope of the same technical idea, which are also be considered to fall within the scope of the present disclosure.

What is claimed is:

1. A coil supply device configured to supply a material coil to a coil forming system for forming a hairpin-shaped stator coil, the coil supply device comprising:
a feeding case configured to transfer the material coil from a front portion of the feeding case to a rear portion of the feeding case, the feeding case comprising (i) a front coil guide coupled to the front portion of the feeding case and (ii) a rear coil guide coupled to the rear portion of the feeding case, the front and rear coil guides being configured to guide the material coil along a set coil conveying section disposed between the front portion and the rear portion of the feeding case;
a belt driver disposed at the feeding case;
a feeding belt connected to the belt driver and configured to travel along a track, the feeding belt being divided into (i) straight sections disposed at lateral sides of the feeding case and (i) rounded sections disposed at front and rear sides of the feeding case;
a plurality of coil gripper assemblies arranged at the feeding belt at intervals along a belt travel direction of the feeding belt, each of the coil gripper assemblies comprising (i) an upper finger and a lower finger that are configured to move in an upper-lower direction, and (ii) an upper cam mechanism and a lower cam mechanism that are configured to move the upper finger and the lower finger in the upper-lower direction, respectively;
an upper guide rail mounted on an upper portion of the feeding case and having an upper cam projection section configured to come into cam contact with the upper cam mechanism at a position corresponding to the coil conveying section; and
a lower guide rail disposed at a lower portion of the feeding case, the lower guide rail having a lower cam projection section configured to come into contact with the lower cam mechanism at a position corresponding to the coil conveying section.

2. The coil supply device of claim 1, wherein the belt driver comprises:
a motor disposed at the feeding case;
a drive pulley disposed in the feeding case and connected to the motor through a drive shaft, the drive pulley being configured to drive movement of the feeding belt; and
a driven pulley disposed in the feeding case and spaced apart from the drive pully by a set interval, the driven pulley being connected to the drive pulley through the feeding belt.

3. The coil supply device of claim 1, wherein each of the coil gripper assemblies comprises:
a base plate coupled to the feeding belt;
an upper finger holder that is fixed to an upper portion of the base plate and accommodates at least a portion of the upper finger, wherein the upper finger is configured to move relative to the upper finger holder in the upper-lower direction via at least one upper spring;
a lower finger holder that is fixed to a lower portion of the base plate and accommodates at least a portion of the lower finger, wherein the lower finger is configured to move relative to the lower finger holder in the upper-lower direction via at least one lower spring;
an upper cam roller rotatably disposed at an upper portion of the upper finger and configured to roll based on being in contact with the upper cam projection section; and
a lower cam roller rotatably disposed at a lower portion of the lower finger and configured to roll based on being in contact with the lower cam projection section.

4. The coil supply device of claim 3, wherein the feeding belt comprises nuts that are arranged on a belt surface in the upper-lower direction, and
wherein the base plate is fastened to the nuts via bolts.

5. The coil supply device of claim 4, wherein the base plates of the coil gripper assemblies disposed at the straight sections of the feeding belt are in contact with the belt surface of the feeding belt, and
wherein the base plates of the coil gripper assemblies disposed at the rounded sections of the feeding belt are spaced apart from the belt surface of the feeding belt.

6. The coil supply device of claim 1, further comprising:
a plurality of support blocks arranged between the coil gripper assemblies and fixed to the feeding belt.

7. The coil supply device of claim 1, wherein the upper cam projection section and the lower cam projection section are disposed along the coil conveying section at a position corresponding to one of the straight sections disposed at a first side of the feeding belt.

8. The coil supply device of claim 7, wherein the upper guide rail comprises an upper plane section that is connected to the upper cam projection section and that is disposed at positions corresponding to (i) another of the straight sections disposed at a second side of the feeding belt and (ii) the rounded sections of the feeding belt, and
wherein the lower guide rail comprises a lower plane section that is connected to the lower cam projection section and that is disposed at the positions corresponding to (i) the straight section disposed at the second side of the feeding belt and (ii) the rounded sections of the feeding belt.

9. The coil supply device of claim 8, wherein the upper cam projection section and the lower cam projection section define a coil gripping area of the coil gripper assemblies, and
wherein the upper plane section and the lower plane section define a coil ungripping area of the coil gripper assemblies.

10. The coil supply device of claim 9, wherein the coil gripper assemblies are configured to grip the material coil based on the upper finger and the lower finger moving toward each other by the upper cam mechanism and the lower cam mechanism, respectively, to thereby contact the upper cam projection section and the lower cam projection section in the coil gripping area.

11. The coil supply device of claim 9, wherein the coil gripper assemblies are configured to ungrip the material coil based on the upper finger and the lower finger moving away from each other by the upper cam mechanism and the lower cam mechanism, respectively, to thereby contact the upper plane section and the lower plane section in the coil ungripping area.

12. The coil supply device of claim 1, further comprising:
an upper rail height adjuster disposed at the upper portion of the feeding case and connected to the upper guide rail; and
a lower rail height adjuster disposed at the lower portion of the feeding case and connected to the lower guide rail.

13. The coil supply device of claim 12, wherein the upper rail height adjuster comprises:
a height adjustment cylinder that is fixed to the upper portion of the feeding case and comprises an operating rod configured move forward and rearward in a front-rear direction;
an upper slider connected to the operating rod and coupled to the upper portion of the feeding case, the upper slider being configured to move in the front-rear direction;
an upper guider that connects the upper slider to the upper portion of the feeding case;
at least one upper ball joint rotatably coupled to the upper slider; and
at least one upper eccentric shaft rotatably coupled to the upper guide rail and coupled to the at least one upper ball joint.

14. The coil supply device of claim 13, wherein the upper rail height adjuster further comprises an adapter connected to the upper slider, and the operating rod is coupled to the adapter.

15. The coil supply device of claim 12, wherein the lower rail height adjuster comprises:
a ball screw rotatably coupled to the lower portion of the feeding case and arranged along a front-rear direction;
a lower slider coupled to the ball screw and coupled to the lower portion of the feeding case, the lower slider being configured to move in the front-rear direction;
a lower guider that connects the lower slider to the lower portion of the feeding case;
at least one lower ball joint rotatably coupled to the lower slider; and
at least one lower eccentric shaft rotatably coupled to the lower guide rail and coupled to the at least one lower ball joint.
